(19) United States
(12) Patent Application Publication
(10) Pub. No.: US 2014/0193143 A1
(43) Pub. Date: Jul. 10, 2014

(54) HEATED HOSE ASSEMBLY

(71) Applicant: ALLIED PRECISION INDUSTRIES, INC., Elburn, IL (US)

(72) Inventors: THOMAS K. REUSCHE, Elburn, IL (US); Philip E. Chumbley, Aurora, IL (US)

(73) Assignee: ALLIED PRECISION INDUSTRIES, INC., Elburn, IL (US)

(21) Appl. No.: 14/089,254

(22) Filed: Nov. 25, 2013

Related U.S. Application Data
(60) Provisional application No. 61/748,805, filed on Jan. 4, 2013.

(51) Int. Cl. H05B 3/58; F16L 53/00

(52) U.S. Cl. CPC H05B 3/58; F16L 53/008
USPC 392/472

(57) ABSTRACT

A heated hose assembly may include a flexible hose defining an internal water channel and having first and second ends, a first coupling secured to the first end of the flexible hose, a second coupling secured to the second end of the flexible hose, a hose heating element configured to heat the flexible hose, a first coupling heating element secured to at least a portion of the first coupling and configured to heat the first coupling, and a second coupling heating element secured to at least a portion of the second coupling and configured to heat the second coupling.

### CROSS-REFERENCE TO RELATED APPLICATIONS

The present application relates to and claims priority benefits from U.S. Provisional Patent Application No. 61/748,805, entitled “Heated Hose Assembly,” filed Jan. 4, 2013, which is hereby expressly incorporated by reference in its entirety.

### FIELD OF THE DISCLOSURE

Embodiments of the present disclosure generally relate to hose assemblies, and, more particularly, to heated hose assemblies.

### BACKGROUND OF THE DISCLOSURE

In various settings, individuals may desire to channel water from a water source, such as a well, faucet, or the like, to an outdoor location while the ambient temperature is below freezing. For example, a farmer may use a hose to supply water to a stock tank in order to provide drinking water for livestock. As another example, a hose may be used to refill water tanks in a recreational vehicle. Any water that remains within an idle hose and exposed to freezing temperatures will likely freeze, thereby forming a barrier within the hose, or even damaging the hose, such as through bursting or splitting. Even if water is not present within the idle hose, the hose typically becomes stiff and unwieldy when exposed to freezing conditions.

In order to prevent hoses from freezing or becoming difficult to handle, heated garden hoses have been developed. For example, a known heated hose includes a flexible hose having a heating cable within an internal water channel. The heating cable connects to source of power through an unheated pipe section.

Another known heated hose includes a heating element extending along the length of the hose. As yet another example, a heated hose includes a heated conduit system in which part of the system employs a heating element positioned between inner and outer tubes of a flexible hose. Still another known heated hose includes heat tape between inner and outer tubes of the hose. Another example of a known heated hose includes a ground wire running through a hose.

In general, various known heated hoses apply heat to a flexible hose in order to either heat the fluid passing through the hose, or prevent it from freezing. However, typical heated hoses are susceptible to freezing at either end due to unheated metal couplings. As such, water may freeze within or proximate to the metal couplings, thereby forming ice plugs that prevent water from passing. Indeed, the ice formed within or proximate to the metal couplings may damage the flexible hose or even the metal couplings.

### SUMMARY OF EMBODIMENTS OF THE PRESENT DISCLOSURE

Certain embodiments of the present disclosure provide a heated hose assembly that may include a flexible hose defining an internal water channel and having first and second ends, at least one coupling secured to one of the first or second ends of the flexible hose, at least one hose heating element configured to heat the flexible hose, and at least one coupling heating element configured to heat the at least one coupling. The at least one coupling may include first and second couplings. The first coupling is secured to the first end of the flexible hose, and the second coupling is secured to the second end of the flexible hose.

The coupling heating element(s) may be wrapped around at least a portion of the at least one coupling. In at least one embodiment, the hose heating element(s) is connected to the coupling heating element(s). The coupling heating element(s) may contact, such as through abutment, at least a portion of the coupling(s).

The hose heating element(s) may longitudinally extend over at least a portion of a length of the flexible hose. The hose heating element may loop around at least a portion of the central longitudinal axis. At least a portion of the hose heating element(s) may be embedded within at least a portion of the flexible hose.

At least a portion of the hose heating element(s) may extend along a first direction that is parallel with a central longitudinal axis of the heated hose assembly. At least a portion of the coupling heating element(s) wraps around at least a portion of the coupling(s) in a second direction that radially extends around at least a portion of the central longitudinal axis of the heated hose assembly.

The coupling heating element(s) may be connected in series with the hose heating element(s). Alternatively, the coupling heating element(s) may be connected in parallel with the hose heating element(s).

In at least one embodiment, a resistivity exhibited by the coupling heating element(s) may differ from a resistivity exhibited by the hose heating element(s). One or both of the coupling heating element(s) and the hose heating element(s) may include a heating wire.

### BRIEF DESCRIPTION OF THE DRAWINGS

FIG. 1 illustrates a lateral view of a heated hose assembly, according to an embodiment of the present disclosure.

FIG. 2 illustrates an axial cross-sectional view of a heated hose assembly through line 2-2 of FIG. 1, according to an embodiment of the present disclosure.

FIG. 3 illustrates an axial cross-sectional view of a flexible hose, according to an embodiment of the present disclosure.

FIG. 4 illustrates an axial cross-sectional view of a flexible hose, according to an embodiment of the present disclosure.

FIG. 5 illustrates a transverse cross-sectional view of a heated hose assembly, according to an embodiment of the present disclosure.

FIG. 6 illustrates a simplified view of a hose heating element connected to a coupling heating element, according to an embodiment of the present disclosure.

FIG. 7 illustrates a transverse cross-sectional view of a heated hose assembly, according to an embodiment of the present disclosure.

FIG. 8 illustrates a circuit schematic diagram of a hose heating connected in series with coupling heating elements, according to an embodiment of the present disclosure.

FIG. 9 illustrates a circuit schematic diagram of a hose heating element connected in parallel with coupling heating elements, according to an embodiment of the present disclosure.

Before the embodiments of the disclosure are explained in detail, it is to be understood that the disclosure is not limited in its application to the details of construction and the arrangement of the components set forth in the following description or illustrated in the drawings. The disclosure is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE DRAWINGS

Embodiments of the present disclosure provide heated hose assemblies that may include flexible hoses having one or more heating elements. In at least one embodiment, separate and distinct heating elements may be in physical contact with metal connectors or couplings at each end of a heated hose assembly. The separate and distinct heating elements may be connected in series or parallel with one or more hose heating elements secured within a flexible portion of a hose.

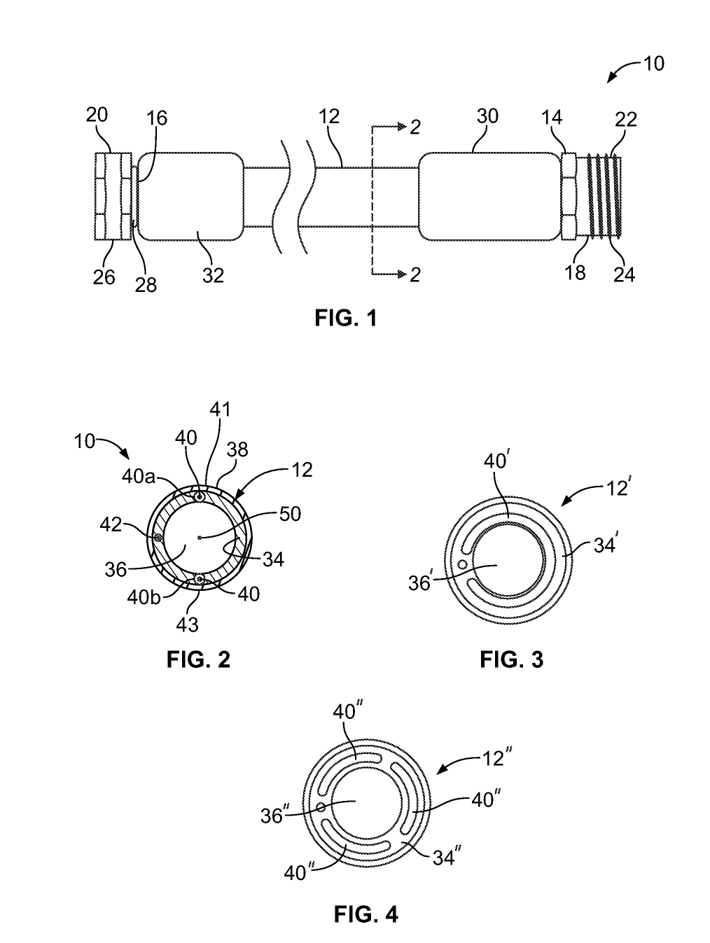

FIG. 1 illustrates a lateral view of a heated hose assembly 10, according to an embodiment of the present disclosure. The heated hose assembly 10 includes a flexible hose 12, such as a garden hose, that defines an internal water channel (not shown in FIG. 1) that extends between openings at either end 14 and 16. A first connector or coupling 18, such as a male coupling, is connected to the end 14 of the flexible hose 12. A second connector or coupling 20, such as a female coupling, is connected to the end 16 of the flexible hose 12.

The first coupling 18 may be formed of a rigid material, such as metal, plastic, glass, or ceramic, and may include an outer circumferential body 22 having external threads 24. The outer circumferential body 22 may connect to a stem (not shown in FIG. 1) that extends into the flexible hose 12. The outer circumferential body 22 and the stem define an internal passage that connects to the opening formed through flexible hose 12. Accordingly, water may pass between the internal passage of the first coupling 18 and the internal water channel formed through the flexible hose 12. The external threads 24 are configured to threadably engage and secure to a reciprocal female coupling, such as may be found on a faucet or a spray nozzle, for example.

The second coupling 20 may also be formed of a rigid material, such as metal, and may include an outer rotatable body 26 rotatably secured to a fixed stem 28 that is secured into the end 16 of the flexible hose 12. The outer rotatable body 26 includes internal threads (not shown in FIG. 1) and defines an internal passage that connects to the opening formed through the flexible hose 12 through the fixed stem 28. As such, water may pass between the internal passage of the second coupling 18 and the internal water channel formed through the flexible hose 12. The internal threads are configured to threadably engage and secure to a reciprocal male coupling, such as may be found an a faucet or spray nozzle, for example.

Alternatively, the first coupling 18 may be a female coupling, while the second coupling 20 may be a male coupling. Also, alternatively, both the first and second couplings 18 and 20 may be male or female couplings.

Protective jackets 30 and 32 surround the flexible hose 12 at the ends 14 and 16, respectively. The protective jackets 30 and 32 may be formed of flexible plastic, rubber, or the like. The protective jackets 30 and 32 surround and protect the unions of the ends 14 and 16 of the flexible hose 12 with the first and second couplings 18 and 20, respectively. Alternatively, the heated hose assembly 10 may not include the protective jackets 30 and 32. Also, alternatively, a single protective jacket may surround an entire length of the flexible hose 12.

FIG. 2 illustrates an axial cross-sectional view of the heated hose assembly 10 through line 2-2 of FIG. 1, according to an embodiment of the present disclosure. The flexible hose 12 may include an inner tubular core 34 defining an internal water channel 36. The inner tubular core 34 may be formed of flexible plastic, rubber, or the like.

An outer sheath 38 may surround the inner tubular core 34. The outer sheath 38 may be formed of a stiffer plastic or rubber and is configured to protect the inner tubular core 34 from damage. Alternatively, the flexible hose 12 may not include the outer sheath 38.

One or more hose heating elements 40 may be secured within the inner tubular core 34. Each hose heating element 40 may be a heating wire, for example. As shown in FIG. 2, two hose heating elements 40a and 40b may be disposed within the inner tubular core 34, although it is to be understood that the hose heating elements 40a and 40b may or may not be separate and distinct heating elements. As an example, the heating elements 40a and 40b may be different portions of a single heating element 40. The hose heating elements 40a and 40b may be extruded and encased within the tubular core 34, and portions of the hose heating elements 40a and 40b may extend into the water channel 36. The hose heating elements 40a and 40b may be positioned 180 degrees (relative to a central axis 50) from one another. Alternatively, the hose heating elements 40a and 40b may be positioned at various other radial positions of inner tubular core 34. Further, a single hose heating element 40 having a plurality of hose heating element portions that extend along more sides of the flexible hose 12 may be used. As such, instead of two heating elements 40a and 40b, three, four, five, six, or more heating element loops may be used.

The hose heating elements 40a and 40b shown in FIG. 2 may be part of a single resistive hose heating element 40 that longitudinally extends along one side 41 of the flexible hose 12, and loops back and longitudinally extends along the opposite side 43 of the flexible hose. Lead wires may connect to the heating element 40 at one end 14 or 16 of the flexible hose 12.

A grounding element 42 may also be secured within the inner tubular core 34. For example, the grounding element 42 may be extruded and encased within the tubular core 34. The grounding element 42 may be a grounding wire. As shown in FIG. 2, the grounding element 42 may be 90 degrees between each of the heating elements 40a and 40b. Alternatively, the grounding element 42 may be positioned at various other portions of the tubular core 34. Optionally, the heated hose assembly 10 may not include the grounding element 42.

Also, alternatively, the hose heating elements 40a and 40b and the grounding element 42 may not be encased in the tubular core 34, as shown in FIG. 2. Instead, the hose heating elements 40a and 40b, and/or the grounding element 42 may be secured to an outer or inner surface of the tubular core 34 or outer sheath 38. Also, alternatively, instead of being secured to a portion of the flexible hose 12, the hose heating elements 40a and 40b may simply be disposed within the water channel 36. As such, the hose heating elements 40a and 40b may freely float or be suspended within the water channel 36.

FIG. 3 illustrates an axial cross-sectional view of a flexible hose 12′, according to an embodiment of the present disclosure. The flexible hose 12′ is similar to the flexible hose 12 shown in FIG. 2, except that a single hose heating element 40′ may wrap around the water channel 36′ within the tubular core 34′.

FIG. 4 illustrates an axial cross-sectional view of a flexible hose 12″, according to an embodiment of the present disclosure. The flexible hose 12″ is similar to the flexible 12′ shown in FIG. 3, except that radial hose heating element segments 40″ may wrap around portions the water channel 36″ within the tubular core 34″. As shown, three evenly spaced hose heating element segments 40″ are positioned within the tubular core 34″. However, more or less hose heating element segments 40″ may be used.

Referring to FIGS. 1 and 2, in a heated hose assembly 10 that includes a resistive heating element, such as a single heating wire that longitudinally extends along the length of the flexible hose 12, the resistance of the wire may be chosen to generate and provide heat everywhere along the flexible hose 12 at a desired voltage. For example, if it is desired to provide 0.5 watts of heat per inch of hose for a 100 ft. hose operating at 120 volts, a calculation may be made to determine the resistivity per foot of the heater wire. At 0.5 watts per inch, the total wattage for a 100 ft. hose is 600 watts. The power P in watts is given by:

P=V²/R, (Equation 1)

where V is the voltage, and R is the total resistance of the wire. Solving Equation 1 for R yields 24 Ohms. Assuming the heater wire runs down and back along the hose, the total length of wire would be 200 feet. Therefore, the resistivity p of the wire of length L is given by Equation 2:

p=R/L, (Equation 2)

which yields ρ=0.12 Ohms/ft. If the hose is 50 feet long instead of 100, the resistivity of the heater wire required to give the same wattage per length of hose would be 0.48 Ohms/ft. As such, the resistivity of the heater wire increases as the length of the hose decreases.

However, while the heating element 40, such as a heating wire, supplies heat to the flexible hose 12, the heating element 40 may be unable to supply heat to the first and second couplings 18 and 20. Therefore, the heated hose assembly 10 may include one or more additional heating elements for each of the first and second couplings 18 and 20. As one example, a heating element 40 may extend past the ends 14 and 16 of the flexible hose 12 and then wrap around internal or external portions of the first and second couplings 18 and 20. However, the mass of each of the first and second couplings 18 and 2 may be greater and have a higher heat capacity than the flexible hose 12. Additionally, the first and second couplings 18 and 20 may not be insulated, and therefore may require more heat to warm. As such, the first and second couplings 18 and 20 may lose heat to the environment quicker than the flexible hose 12. Thus, while 1.5 watts of heat may be sufficient to keep a section, such as a 3 inch section, of the flexible hose 12 from freezing, an increased amount of heat, such as 10 watts of heat, may be needed to sufficiently warm the first and second couplings 18 and 20. In order to provide such heat to the first and second couplings 18 and 20, in the example above, 20 inches of wire may be needed to provide such heat. For a ⅝ inch diameter garden hose, for example, the wire would need to be wrapped ten times around the stem of each coupling, and for a typical wire diameter of 0.1 inch, 1.0 inch would be added to the length of the metal stem on the coupling. Thus, using the same heater wire as used in the flexible hose 12 may require a much larger and more expensive metal coupling.

In order to use smaller, reasonably-priced couplings, therefore, the first and second couplings 18 and 20 may be heated by one or more coupling heating elements that may exhibit a different resistivity from the hose heating element. The coupling heating elements may be spliced to the hose heating element 40 of the flexible hose 12.

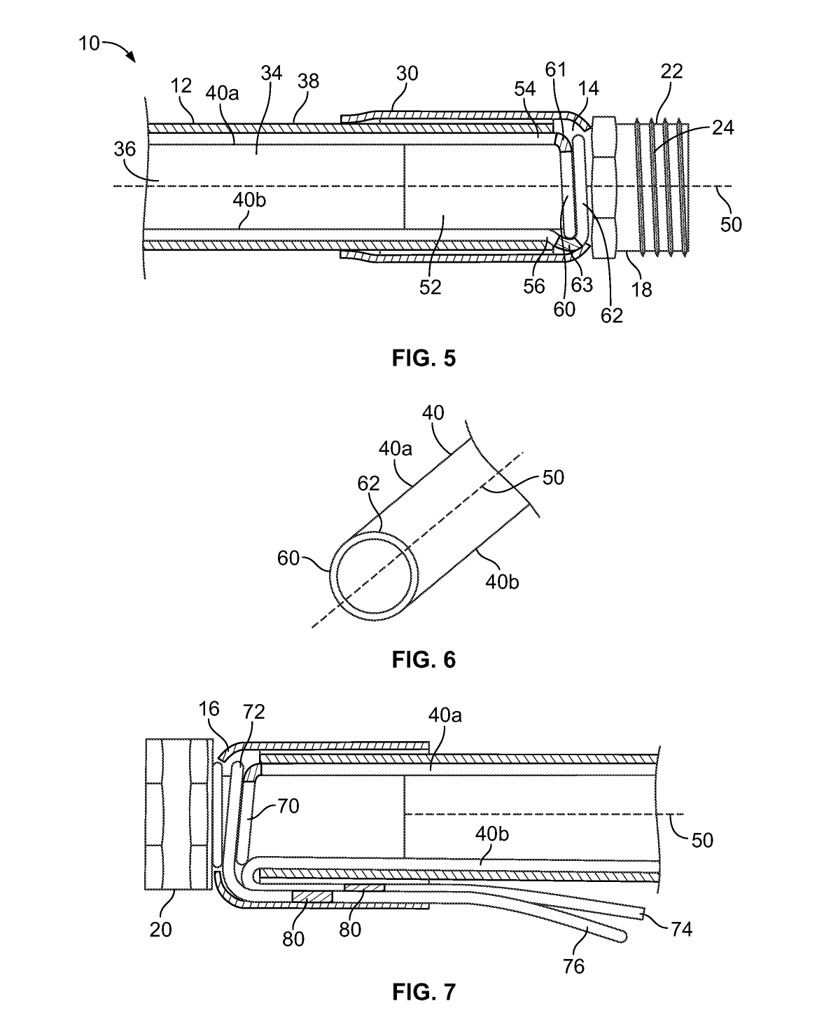

FIG. 5 illustrates a transverse cross-sectional view of a heated hose assembly 10, according to an embodiment of the present disclosure. As shown in FIG. 5, the hose heating elements 40a and 40b, such as heating wires, may extend along a length of the flexible hose 12. Each hose heating element 40a and 40b may be parallel with a central longitudinal axis 50 of the heated hose assembly 10.

A stem 52, which may be expandable, of the first coupling 18 may extend into the water channel 36 from the end 14. The stem 52 may be a part of the first coupling 18 that extends into the flexible hose 12. As such, the stem 52 may also be formed of the same material as the rest of the first coupling 18. Optionally, the stem 52 may be a separate and distinct piece formed of a conductive material that securely connects to the first coupling 18.

Ends 54 and 56 of the hose heating elements 40a and 40b, respectively, may longitudinally extend over the stem 52. Each end 54 and 56 may conductively connect to a coupling heating element 60 and 62, respectively. For example, the ends 54 and 56 may be spliced and/or soldered to the coupling heating elements 60 and 62, respectively. As such, conductive joints 61 and 63 connect the hose heating elements 40a and 40b with the coupling heating elements 60 and 62, respectively.

The coupling heating elements 60 and 62 may include portions that are perpendicular to the hose heating elements 40a and 40b. For example, each coupling heating element 60 and 62 may radially wrap over a portion of the stem 52 in an initial direction that is perpendicular to the hose heating elements 40a and 40b. While the hose heating elements 40a and 40b may extend over a longitudinal portion of the stem 52, the coupling heating elements 60 and 62 may wind around radial outer wall portions of the stem 52.

One or both coupling heating elements 60 and 62 may abut against the first coupling 18. For example, the coupling heating elements 60 and 62 may wrap around the stem 52 of the first coupling 18 or may directly abut into or wrap around at least a portion of the outer circumferential body 22. Moreover, while shown as two separate coupling heating elements 60 and 62, the coupling heating elements 60 and 62 may be a single coupling element having a first end connected to the conductive joint 61 and an opposite end connected to the conductive joint 63.

The coupling heating elements 60 and 62 may wind around the stem 52 and/or any other portion of the first coupling 18. For example, the coupling elements 60 and 62 may helically wind around the stem 52 and/or any other portion of the first coupling 18. While two windings are shown in FIG. 5, more or less windings may be used.

FIG. 6 illustrates a simplified view of the hose heating element 40, including the hose heating elements 40a and 40b, connected to coupling heating elements 60 and 62, according to an embodiment of the present disclosure. As shown, the heating elements 40a and 40b are longitudinally aligned and parallel with the central axis 50. The coupling heating elements 60 and 62 are radially-positioned with respect to the central axis 50.

FIG. 7 illustrates a transverse cross-sectional view of the heated hose assembly 10, according to an embodiment of the present disclosure. The hose heating elements 40a and 40b may connect to coupling heating elements 70 and 72 similar to as described above. Each hose heating element 40a and 40b may also be connected to a lead wire 74 and 76, respectively, through a splice and/or soldered conductive connection 80. As such, electrical power from a power source is provided to the hose heating elements 40a and 40b and the coupling heating elements 70 and 72 (and the coupling heating elements 60 and 62) by way of the lead wires 74 and 76. Optionally, a single lead wire may be used and connect to one of the hose heating elements 40a or 40b, or the coupling heating elements 70 or 72 (or 60 or 62), as all of the heating elements 40a, 40b, 60, 62, 70, and 72 may be connected together through conductive joints.

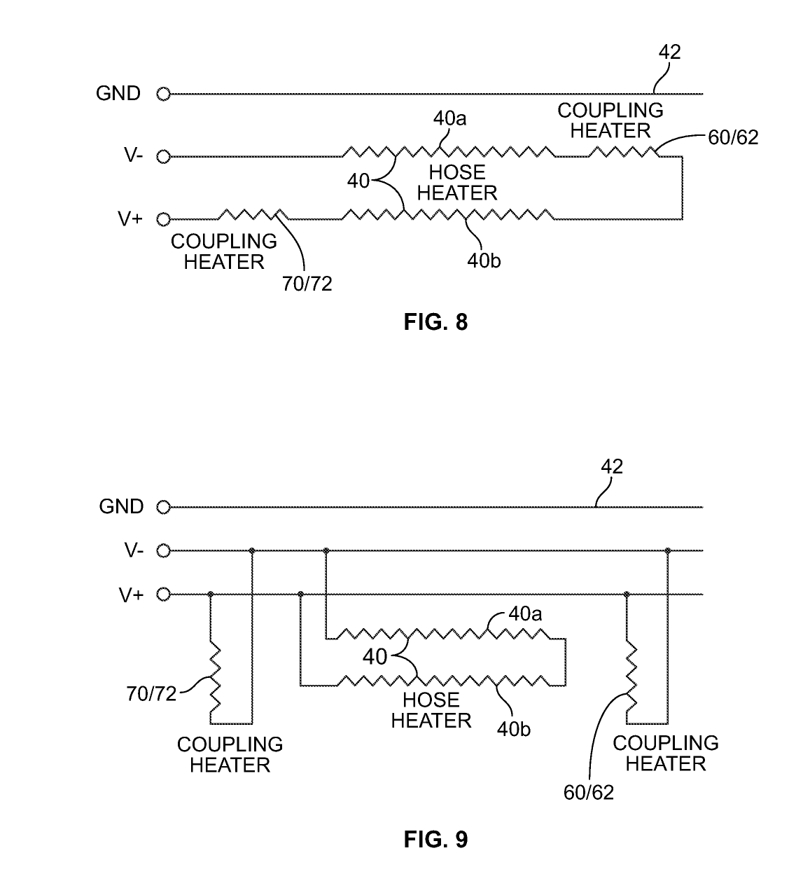

FIG. 8 illustrates a circuit schematic diagram of the hose heating element 40 connected in series with the coupling heating elements 60, 62, 70, and 72, according to an embodiment of the present disclosure. As noted above, the heating elements 40a and 40b may be part of the single heating element 40. Also, each of the coupling heating elements 60 and 62 may be wound portions of a single heating element, while each of the coupling heating elements 70 and 72 may be wound portions of a single heating element. Alternatively, the hose heating element 40 may be connected in parallel with the coupling heating elements 60, 62, 70, and 72.

Referring to FIGS. 5-8, the coupling heating elements 60, 62, 70, and 72 may be heating wires exhibiting different resistivities than that of the heating element 40. However, simply using extra wire of a different resistivity in series with the hose heating element 40 may change the total resistance of the assembly 10, thereby decreasing the wattage along the flexible hose 12. To illustrate, suppose in the example above that it is desired to supply 10 watts of heat to each of the first and second couplings 18 and 20. In such an example, the total wattage of the heated hose assembly 10 is 620 watts. Referring to Equation 3,

P=i×V, (Equation 3)

where i is the current, and the current would be 5.17 amps. Then, referring to Equation 4,

P=i²×R, (Eqn. 4)

total resistance for each section of wire may be derived. Thus for a flexible hose with a wattage of 600 watts, a resistance R=22.45 Ohms is produced, thereby yielding a resistivity of 0.11 Ohms/ft, as compared to 0.12 Ohms/ft previously. While this may seem like a small difference, if the change in wire resistivity is not made, it would decrease the amount of heat supplied to the flexible hose 12 by almost 6% to 565 watts.

For each coupling with a wattage of 10 watts, a resistance R=0.37 Ohms is produced. If a coupling heating element, such as a heating wire, is wrapped only once around a ⅝ inch stem, a resistivity of 2.26 Ohms/ft would result. Therefore, the resistivity of the coupling heating elements around each of the first and second couplings 18 and 20 is quite different from that of the hose heating element 40 along the flexible hose 12.

FIG. 9 illustrates a circuit schematic diagram of the hose heating element 40 connected in parallel with the coupling heating elements 60, 62, 70, and 72, according to an embodiment of the present disclosure. Referring to FIGS. 5-7 and 9, the resistivity of each heating element is independent of the others and may be selected to operate at 120 volts, for example. This yields the original resistivity of 0.12 Ohms/ft for the hose heating element 40, and 8801 Ohm/ft for the coupling heating elements 60, 62, 70, and 72. As such, it is clearly seen that the resistivity of the coupling heating elements 60, 62, 70, and 72 becomes relatively high as compared to the hose heating element.

Referring to FIGS. 1-9, embodiments of the present disclosure provide heated hose assemblies that include at least one hose heating element that may extend along a length of a flexible hose and one or more coupling heating elements configured to supply heat to one or more couplings at either end of the flexible hose. Certain embodiments of the heating elements may utilize resistive wire, polymer, and/or resistive ink. The heating elements may be connected in a loop with all of the heating elements in the hose connected in series. Alternatively, the heating elements may be configured in a “ladder” type arrangement with two power leads and shorter heater sections connected in parallel with one another between the power leads. One or both couplings may be heated by heating elements in physical contact with a section of each coupling. The couplings may be made of any sturdy material such as metal, plastic, glass, or ceramic.

The coupling heating element(s) may exhibit a different resistivity than that of the hose heating element(s). When connected in series, the resistivity of the hose heating element may be adjusted to compensate for the increased resistance in the circuit due to the inclusion of the coupling heating element(s) so that the total amount of heat supplied to the flexible hose and to each coupling is as desired.

In contrast to known heated hoses, embodiments of the present disclosure are less susceptible to freezing at either end proximate to the couplings.

While various spatial and directional terms, such as top, bottom, lower, mid, lateral, horizontal, vertical, front, and the like may be used to describe embodiments of the present disclosure, it is understood that such terms are merely used with respect to the orientations shown in the drawings. The orientations may be inverted, rotated, or otherwise changed, such that an upper portion is a lower portion, and vice versa, horizontal becomes vertical, and the like.

It is to be understood that the above description is intended to be illustrative, and not restrictive. For example, the above-described embodiments (and/or aspects thereof) may be used in combination with each other. In addition, many modifications may be made to adapt a particular situation or material to the teachings without departing from its scope. While the dimensions, types of materials, and the like described herein are intended to define the parameters of the disclosure, they are by no means limiting and are exemplary embodiments. Many other embodiments will be apparent to those of skill in the art upon reviewing the above description. The scope of the disclosure should, therefore, be determined with reference to the appended claims, along with the full scope of equivalents to which such claims are entitled. In the appended claims, the terms “including” and “in which” may be used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

What is claimed is:

1. A heated hose assembly comprising:
a flexible hose defining an internal water channel and having first and second ends;
at least one coupling secured to one of the first or second ends of the flexible hose;
at least one hose heating element configured to heat the flexible hose; and
at least one coupling heating element configured to heat the at least one coupling.

2. The heated hose assembly of claim 1, wherein the at least one coupling comprises first and second couplings, wherein the first coupling is secured to the first end of the flexible hose, and wherein the second coupling is secured to the second end of the flexible hose.

3. The heated hose assembly of claim 1, wherein the at least one coupling heating element is wrapped around at least a portion of the at least one coupling.

4. The heated hose assembly of claim 1, wherein the at least one hose heating element longitudinally extends over at least a portion of a length of the flexible hose.

5. The heated hose assembly of claim 1, wherein at least a portion of the at least one hose heating element extends along a first direction that is parallel with a central longitudinal axis of the heated hose assembly, and wherein at least a portion of the at least one coupling heating element wraps around at least a portion of the at least one coupling in a second direction that radially extends around at least a portion of the central longitudinal axis of the heated hose assembly.

6. The heated hose assembly of claim 5, wherein the at least one hose heating element loops around at least a portion of the central longitudinal axis.

7. The heated hose assembly of claim 1, wherein the at least one hose heating element is connected to the at least one coupling heating element.

8. The heated hose assembly of claim 1, wherein at least a portion of the at least one hose heating element is embedded within at least a portion of the flexible hose.

9. The heated hose assembly of claim 1, wherein the at least one coupling heating element contacts at least a portion of the at least one coupling.

10. The heated hose assembly of claim 1, wherein the at least one coupling heating element is connected in series or parallel with the at least one hose heating element.

11. The heated hose assembly of claim 1, wherein a first resistivity of the at least one coupling heating element differs from a second resistivity of the at least one coupling heating element.

12. The heated hose assembly of claim 1, wherein one or both of the at least one coupling heating element and the at least one hose heating element comprises a heating wire.

13. A heated hose assembly comprising:
a flexible hose defining an internal water channel and having first and second ends;
a first coupling secured to the first end of the flexible hose;
a second coupling secured to the second end of the flexible hose;
a hose heating element configured to heat the flexible hose, wherein the hose heating element exhibits a first resistivity;
a first coupling heating element secured to at least a portion of the first coupling and configured to heat the first coupling; and
a second coupling heating element secured to at least a portion of the second coupling and configured to heat the second coupling, wherein the first and second coupling heating elements exhibit a second resistivity that differs from the first resistivity.

14. The heated hose assembly of claim 13, wherein the first coupling heating element is wrapped around at least the portion of the first coupling, and wherein the second coupling heating element is wrapped around at least the portion of the second coupling.

15. The heated hose assembly of claim 13, wherein the hose heating element longitudinally extends over at least a portion of a length of the flexible hose.

16. The heated hose assembly of claim 13, wherein at least a portion of the hose heating element extends along a first direction that is parallel with a central longitudinal axis of the heated hose assembly, wherein at least portion of the first coupling heating element wraps around at least the portion of the first coupling in a second direction that radially extends around a first portion of the central longitudinal axis of the flexible hose, and wherein at least portion of the second coupling heating element wraps around at least the portion of the second coupling in a second direction that radially extends around a second portion of the central longitudinal axis of the flexible hose.

17. The heated hose assembly of claim 14, wherein the hose heating element loops around at least a portion of the central longitudinal axis.

18. The heated hose assembly of claim 13, wherein the hose heating element is connected to the first and second coupling heating elements.

19. The heated hose assembly of claim 13, wherein at least a portion of the hose heating element is embedded within at least a portion of the flexible hose.

20. The heated hose assembly of claim 13, wherein the first and second coupling heating elements contact at least portions of the first and second couplings, respectively.
